(19) United States
(12) Patent Application Publication
(10) Pub. No.: US 2026/0028456 A1
(43) Pub. Date: Jan. 29, 2026

(54) COPROCESSING RENEWABLE RESOURCES TO PRODUCE RENEWABLE FUELS

(71) Applicant: Chevron U.S.A. Inc., San Ramon, CA (US)

(72) Inventors: Bo Kou, Albany, CA (US); Michelle K. Young, Manvel, TX (US); Ramin Abhari, Bixby, OK (US); Shuwu Yang, Richmond, CA (US); Theodorus Ludovicus Michael Maesen, Spring, TX (US)

(21) Appl. No.: 19/233,380

(22) Filed: Jun. 10, 2025

Related U.S. Application Data
(60) Provisional application No. 63/674,977, filed on Jul. 24, 2024.

(51) Int. Cl. C08H 7/00; C10L 1/04

(52) U.S. Cl. CPC C08H 6/00; C10L 1/04; C10L 2200/0469

(57) ABSTRACT

A process includes coprocessing a slurry hydroprocessing feed stream comprising a solid biomass feedstock and a liquid feedstock including one or more of fats, oils and greases in the presence of a slurry hydroprocessing catalyst and hydrogen in a slurry hydroprocessing zone and under slurry hydroprocessing conditions to produce a liquid hydroprocessing effluent having a first n-paraffin content and a first aromatic content, and coprocessing the liquid hydroprocessing effluent by subjecting the liquid hydroprocessing effluent to a hydrodeoxygenation catalyst and under hydrodeoxygenation reaction conditions to produce a hydrodeoxygenated liquid effluent, and subjecting the hydrodeoxygenated liquid effluent to a hydroisomerization catalyst and under hydroisomerization reaction conditions thereby producing a liquid hydrocarbon product having a second n-paraffin content less than the first n-paraffin content and a second aromatic content less than the first aromatic content.

### PRIORITY CLAIM

The present application claims priority to U.S. Provisional Patent Application No. 63/674,977, entitled “Coprocessing Renewable Resources to Produce Renewable Fuels,” filed Jul. 24, 2024, the content of which is incorporated by reference herein in its entirety.

### BACKGROUND

The ongoing search for alternatives to crude is increasingly driven by a number of factors. These include diminishing petroleum reserves, higher anticipated energy demands, and heightened concerns over greenhouse gas emissions from sources of non-renewable carbon. In order to mitigate the effects of greenhouse gases, efforts have been made to reduce the global carbon footprint. To realize these reductions, the world is transitioning away from solely conventional carbon-based fossil fuel energy carriers. For example, energy conservation, improvements in energy efficiency and electrification may play a role, but also efforts to use renewable resources for the production of fuels and fuel components and/or chemical feedstocks. Thus, there is an increasing interest in alternative feedstocks for replacing at least partly crude oil, in the production of hydrocarbons, suitable as fuels or fuel components such as, for example, transportation fuels, or compatible with fuels.

### SUMMARY

In accordance with an illustrative embodiment, a process for producing a liquid hydrocarbon comprises:
coprocessing a slurry hydroprocessing feed stream comprising a solid biomass feedstock and a liquid feedstock comprising one or more of fats, oils and greases in the presence of a slurry hydroprocessing catalyst and hydrogen in a slurry hydroprocessing zone and under slurry hydroprocessing conditions to produce a liquid hydroprocessing effluent having a first n-paraffin content greater than or equal to about 60 vol. %, and a first aromatic content of greater than or equal to about 10 vol. %, and
processing the liquid hydroprocessing effluent by subjecting the liquid hydroprocessing effluent to a hydrodeoxygenation catalyst and under hydrodeoxygenation reaction conditions to produce a hydrodeoxygenated liquid effluent, and subjecting the hydrodeoxygenated liquid effluent to a hydroisomerization catalyst and under hydroisomerization reaction conditions, thereby producing a liquid hydrocarbon product having a second n-paraffin content less than the first n-paraffin content and a second aromatic content less than the first aromatic content.

### BRIEF DESCRIPTION OF THE DRAWING

In combination with the accompanying drawing and with reference to the following detailed description, the features, advantages, and other aspects of the implementations of the present disclosure will become more apparent, and several implementations of the present disclosure are illustrated herein by way of example but not limitation. The principles illustrated in the example embodiments of the drawing can be applied to alternate processes and apparatus. Additionally, the elements and features shown in the drawing are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements. In the accompanying drawing:

FIG. 1 illustrates a process and system for coprocessing a solid biomass feedstock and a liquid feedstock comprising one or more of fats, oils and greases to produce a renewable fuel, according to an illustrative embodiment.

### DETAILED DESCRIPTION

Various illustrative embodiments described herein are directed to processes and systems for coprocessing a solid biomass feedstock and a liquid feedstock comprising one or more of fats, oils and greases to produce, for example, a renewable fuel such as diesel fuel, jet fuel, gasoline and sustainable aviation fuels (SAF). The coprocessing of a solid biomass feedstock and a liquid feedstock comprising one or more of fats, oils and greases into, for example, added value fuels, also offers one alternative to crude.

Different types of sustainable aviation fuel (SAF) need their own American Fuel & Petrochemical Manufacturers (AFPM) annex because an SAF derived from a biomass feedstock such as lignin is too aromatic (which would produce excessive soot causing engine malfunctions) and an SAF derived from fats oils and greases (FOG) is too paraffinic (thereby lacking energy intensity and lacking the ability to retain the swelling of the elastomers that seal the fuel system for the airplane's engine). The lack of aromatics in a FOG-derived SAF results in a blending wall, requiring that an airplane such as a jet contain about 25% mineral-oil-based jet fuel in order to reach the required 8% aromatic content. In view of these challenges, there is a need for solutions to avoid the SAF blending wall by turning the FOG feedstock into aromatics to produce value-added fuels.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While systems and processes are described in terms of “comprising” various components or steps, the systems and processes can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “hydroprocessing” generally encompasses all processes in which a hydrocarbon feedstock is reacted with hydrogen in the presence of a catalyst and under hydroprocessing conditions, typically, at elevated temperature and elevated pressure. Hydroprocessing includes, for example, processes such as hydrogenation, hydrodeoxygenation, hydrodesulfurization, hydrodenitrogenation, hydrodemetallization, hydrodearomatization, hydroisomerization, hydrodewaxing, hydrocracking and mild hydrocracking.

The term “hydrotreating” refers to processes wherein a hydrogen-containing treat gas is used in the presence of suitable catalysts which are primarily active for the removal of heteroatoms, such as sulfur, nitrogen, oxygen and metals from the hydrocarbon feedstock. In hydrotreating, hydrocarbons with double and triple bonds such as olefins may be saturated. Aromatics may also be saturated. Some hydrotreating processes are specifically designed to saturate aromatics. In hydrotreating, a feed derived from a biological source is subjected to hydrodeoxygenation, decarboxylation and/or decarbonylation.

The term “renewable” refers to a material that is produced from a renewable resource, which is a resource produced via a natural process at a rate comparable to its rate of consumption (e.g., within a 100-year time frame). The renewable resource can be replenished naturally or via agricultural techniques. Non-limiting examples of renewable resources include plants, animals, fish, bacteria, fungi, and forestry products. These resources can be naturally occurring, hybrids, or genetically engineered organisms. Natural resources such as crude oil (petroleum), natural gas, coal, peat, etc. take longer than 100 years to form and thus they are not considered renewable resources.

The term “biocrude” refers to oils produced from biomass by employing any liquefaction process such as a hydrothermal liquefaction, pyrolysis and hydropyrolysis, or processed oils which contain oxygen.

The terms “upgrade,” “upgrading” and “upgraded,” when used to describe a feedstock that is being or has been subjected to hydroprocessing, or a resulting material or product, refer to one or more of a reduction in molecular weight of the feedstock, a reduction in boiling point range of the feedstock, a reduction in concentration of hydrocarbon free radicals, and/or a reduction in quantity of impurities, such as sulfur, nitrogen, oxygen, halides, and metals.

The term “zone” can refer to an area including one or more equipment items and/or one or more sub-zones. Equipment items can include one or more reactors or reactor vessels, separation vessels, distillation towers, heaters, exchangers, pipes, pumps, compressors, and controllers. Additionally, an equipment item, such as a reactor, dryer, or vessel, can further include one or more zones or sub-zones.

The term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed. For example, a slipstream may carry some of the effluent away, meaning that only a portion of the effluent may enter the downstream component or system.

The terms “wt. %,” “vol. %” or “mol. %” refers to a weight, volume, or molar percentage of a component, respectively, based on the total weight, the total volume, or the total moles of material that includes the component. In a non-limiting example, 10 moles of component in 100 moles of the material are 10 mol. % of component.

The non-limiting illustrative embodiments described herein overcome the drawbacks discussed above by providing systems and processes for coprocessing a liquid feedstock comprising one or more of fats, oils and greases and a solid biomass feedstock to produce, for example, renewable fuels such as diesel fuel, gasoline and sustainable aviation fuels. Advantages of the non-limiting illustrative embodiments described herein include, for example, the use of the liquid feedstock comprising one or more of fats, oils and greases as a liquid carrier for a solid biomass feedstock avoids the use of alternative liquid carriers in the process. Other advantages include that (1) the liquid feedstock comprising one or more of fats, oils and greases advantageously provides additional hydrogen for converting the solid biomass feedstock into a liquid biomass feedstock thus allowing for less hydrogen to be sent into the hydroprocessing reactor unit, (2) the solid biomass provides the required aromaticity to meet the jet fuel standard and (3) the coprocessing of the liquid feedstock and solid biomass reduces the number of equipment, the process complexity and energy consumption.

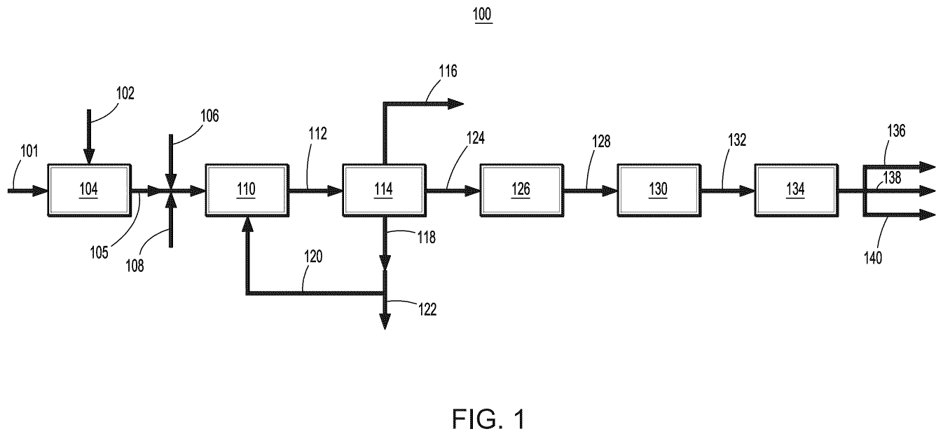

The non-limiting illustrative embodiments of the present disclosure will be specifically described below with reference to the accompanying drawing. For the purpose of clarity, some steps leading up to the production of a renewable fuel as illustrated in FIG. 1 may be omitted. In other words, one or more well-known processing steps which are not illustrated but are well-known to those of ordinary skill in the art have not been included in the figure. This is not intended to be interpreted as a limitation of any particular embodiment, or illustration, or scope of the claims.

FIG. 1 shows a system 100 including a mixing unit 104 for receiving a first feedstock 101 and a second feedstock 102 to produce a slurry effluent 105. In some embodiments, first feedstock 101 to be employed herein includes, for example, one or more of fats, oils and greases. In some embodiments, first feedstock 101 includes, for example, one or more of animal fats, animal oils, plant fats, plant oils, vegetable fats, vegetable oils, greases, and used cooking oil. In some embodiments, suitable animal fats and/or animal oils may include, for example, inedible tallow, edible tallow, technical tallow, floatation tallow, lard, poultry fat (e.g., chicken fat), poultry oils, fish fat, fish oils, and mixtures thereof. In some embodiments, suitable plant and/or vegetable oils may include, for example, babassu oil, carinata oil, soybean oil, inedible corn oil, canola oil, coconut oil, rapeseed oil, tall oil, tall oil fatty acid, palm oil, palm oil fatty acid distillate, palm sludge oil, jatropha oil, palm kernel oil, sunflower oil, castor oil, camelina oil, archaeal oil, and mixtures of any two or more thereof. These may be classified as crude, degummed, and RBD (refined, bleached, and deodorized) grade, depending on level of pretreatment and residual phosphorus and metals content. However, any of these grades may be used in the present disclosure. In some embodiments, suitable greases may include, for example, yellow grease, brown grease, used cooking oil, waste vegetable oils, restaurant greases, trap grease from municipalities such as water treatment facilities, and spent oils from industrial packaged food operations and mixtures of any two or more thereof. For example, in any embodiment herein, the composition may include yellow grease, brown grease, floatation grease, poultry fat, inedible corn oil, used cooking oil, inedible tallow, floatation tallow, palm sludge oil, or a mixture of any two or more thereof. In some embodiments, first feedstock 101 can be a mixture of two or more of any of the foregoing animal fats, animal oils, plant fats, plant oils, vegetable fats, vegetable oils, greases, and used cooking oil.

The term “microbial oils” refers to triglycerides (lipids) produced by microbes. The term “algal oils” refers to oils derived directly from algae. The term “animal fats and oils” refers to lipid materials derived from animals.

In some embodiments, first feedstock 101 can contain relatively high amounts of contaminants such as phosphorus, silicon, and chlorine compounds, as well as various solubilized metals and polymers (e.g., polyethylene). For example, in some embodiments, first feedstock 101 can have a phosphorus and metals content greater than about 10 weight parts per million (wppm). In some embodiments, first feedstock 101 can have a phosphorus and metals content greater than about 100 wppm. In some embodiments, first feedstock 101 can have a phosphorus and metals content of no more than about 1000 wppm. In some embodiments, first feedstock 101 can have a phosphorus and metals content of no more than about 1500 wppm. In some embodiments, first feedstock 101 can be a non-pretreated feedstock. If required, these contaminants can be removed from first feedstock 101 before being introduced to the process of the present disclosure. Methods to remove these contaminants are known to the person skilled in the art.

In some embodiments, second feedstock 102 to be employed herein includes, for example, one or more of a residual waste feedstock and a biomass feedstock containing lignin.

In some embodiments, second feedstock 102 to be employed herein is in solid form. In non-limiting illustrative embodiments, a solid form includes, for example, particles, pellets, shavings, fibers, needles and/or other geometries. The solid form does not necessarily have to have a homogeneous configuration. Instead, the configuration may be regular or irregular. For example, in the case of the solid form comprising particles, the particles can be, for example, virtually spherical particles, and likewise particles having an irregular and/or angular outward shape. In addition, the surface of the particles may be smooth, but it is also possible that the surface of the material is rough and/or has unevenness and/or depressions and/or elevations. In an illustrative embodiment, a solid form can contain particles of second feedstock 102 having a particle size of about 1 millimeter (mm) to about 3.5 mm.

Mixing unit 104 includes a first inlet for receiving first feedstock 101 and a second inlet for receiving second feedstock 102. However, it is also contemplated that first feedstock 101 and second feedstock 102 can be co-fed to mixing unit 104. Mixing unit 104 can be any conventional mixing unit known in the art for combining first feedstock 101 and second feedstock 102 to form slurry effluent 105.

The amount of first feedstock 101 and second feedstock 102 in slurry effluent 105 can be determined by the composition of first feedstock 101, the composition of second feedstock 102, and/or the desired specification of the resulting product. First feedstock 101 is utilized in mixing unit 104 as a liquid carrier for second feedstock 102 in solid form to form slurry effluent 105. In some embodiments, slurry effluent 105 can contain from about 50 wt. % to about 90 wt. % of first feedstock 101 and from about 10 wt. % to about 50 wt. % of second feedstock 102. In some embodiments, slurry effluent 105 can contain from about 60 wt. % to about 90 wt. % of first feedstock 101 and from about 10 wt. % to about 40 wt. % of second feedstock 102. In some embodiments, slurry effluent 105 can contain from about 70 wt. % to about 90 wt. % of first feedstock 101 and from about 10 wt. % to about 30 wt. % of second feedstock 102.

System 100 further includes a slurry reactor 110 for receiving slurry effluent 105, a hydrogen stream 106 and a slurry hydroprocessing catalyst 108. The slurry hydroprocessing process can be carried out in a variety of slurry reactors. Suitable slurry reactors include, for example, continuous stirred tank reactors, fluidized bed reactors, spouted bed reactors, spray reactors, bubble column reactors, liquid recirculation reactors, slurry recirculation reactors, and combinations thereof. Slurry reactor 110 may be a single-stage or multi-stage and may be comprised of a single reactor or multiple reactors. In some embodiments, one or more slurry reactors may be utilized in parallel or in series. In one embodiment, slurry reactor 110 is an up-flow reactor. In another embodiment, slurry reactor 110 is a down-flow reactor. Generally, the vapor outlet from a slurry reactor is above the inlet. The slurry outlet may be above or below the inlet.

In some embodiments, the slurry hydroprocessing process uses a dispersed catalyst which is continuously doped into the feed. In some embodiments, the catalyst can correspond to one or more catalytically active metals in particulate form and/or supported on particles. Catalytically active metals for use in the slurry hydroprocessing process can include those from Groups 4-12 of the IUPAC Periodic Table of Elements. Suitable metals include, for example, iron, nickel, molybdenum, zinc, vanadium, tungsten, cobalt, ruthenium, and any combination thereof. The catalytically active metal may be present as a solid particulate in elemental form or as an organic compound or an inorganic compound such as a sulfide or other ionic compound. Metal or metal compound nanoaggregates may also be used to form the solid particulates.

In some embodiments, slurry hydroprocessing catalyst 108 includes sulfided catalytically active metals. Examples of suitable catalytically active metals include, without limitation, sulfided nickel, sulfided cobalt, sulfided molybdenum, sulfided tungsten, sulfided CoMo, sulfided NiMo, sulfided MoW, sulfided NiW, and combinations thereof.

A catalyst in the form of a solid particulate is generally a compound of a catalytically active metal, or a metal in elemental form, either alone or supported on a refractory material such as an inorganic metal oxide (e.g., alumina, silica, titania, zirconia, and any combination thereof). Other suitable refractory materials can include carbon, coal, and clays. Zeolites and non-zeolitic molecular sieves are also useful as solid supports. In some embodiments, a supported catalyst can have from about 0.01 wt. % to about 30 wt. % of the catalytic active metal based on the total weight of the catalyst.

In some embodiments, it can be desirable to form slurry hydroprocessing catalyst 108 for the slurry hydroprocessing process in situ, such as forming a catalyst from a metal sulfate (e.g., iron sulfate monohydrate) catalyst precursor or another type of catalyst precursor that decomposes or reacts in the hydroprocessing reaction zone environment, or in a pretreatment step, to form a desired, well-dispersed and catalytically active solid particulate (e.g., as iron sulfide). Precursors also include oil-soluble organometallic compounds containing the catalytically active metal of interest that thermally decompose to form the solid particulate (e.g., iron sulfide) having catalytic activity. Other suitable precursors include metal oxides that may be converted to catalytically active (or more catalytically active) compounds such as metal sulfides. In a particular embodiment, a metal oxide containing mineral may be used as a precursor of a solid particulate comprising the catalytically active metal (e.g., iron sulfide) on an inorganic refractory metal oxide support (e.g., alumina).

In some embodiments, slurry hydroprocessing catalyst 108 comprises one or more of molybdenum sulfide, iron sulfide, nickel sulfide, zinc sulfide, and iron zinc.

In some embodiments, suitable catalyst slurry concentrations can range from about 0.005% to about 3% on a metal basis (e.g., about 0.02% to about 1% on a metal basis).

Slurry hydroprocessing catalyst 108 may be present in slurry effluent 105, e.g., preloaded/supported onto slurry effluent 105. In some embodiments, slurry hydroprocessing catalyst 108 may be injected into the slurry reactor 110 as a separate stream.

Slurry hydroprocessing catalyst 108 used in conjunction with the processes described herein may have an average particle size of about 250 microns or less (e.g., about 100 microns or less). The particle size is the length of the largest orthogonal axis through the particle. Average particle size is the average particle diameter of all the catalyst particles fed to the reactor which may be determined by a representative sampling.

Hydrogen stream 106 includes hydrogen, which is contained in a hydrogen “treat gas,” for injecting into slurry reactor 110. The treat gas can be either pure hydrogen or a hydrogen-containing gas, which is a gas stream containing hydrogen in an amount that is sufficient for the intended reaction(s), optionally including one or more other gases (e.g., nitrogen and light hydrocarbons such as methane). The treat gas stream introduced into a reaction stage can contain at least about 50 vol. % or at least about 75 vol. % hydrogen. Optionally, the hydrogen treat gas can be substantially free (less than 1 vol. %) of impurities such as H₂S and NH₃ and/or such impurities can be substantially removed from a treat gas prior to use. Hydrogen can be supplied co-currently with the input feed to slurry reactor 110 or separately via a separate gas conduit.

In general, any suitable slurry hydroprocessing process conditions may be used. In some embodiments, slurry hydroprocessing conditions include, for example, a pressure in a range of from about 500 pounds per square inch gauge (psig) to about 3500 psig (about 3.4 MPa to about 24.1 MPa), or about 1000 psig to about 2500 psig (about 6.9 MPa to about 17.2 MPa), and a reactor temperature in a range from about 250° C. to about 500° C., or about 330° C. to about 400° C. The liquid hourly space velocity (LHSV) is typically below about 4 h⁻¹ on a fresh feed basis, with a range of from about 0.1 h⁻¹ to about 3 h 1, or about 0.1 h⁻¹ to about 1 h⁻¹. The amount of hydrogen stream 106 used for slurry hydroprocessing can be up to about 8000 scf/B (about 1425 m³/m³), such as up to about 10000 scf/B (1781 m³/m³) or more.

The slurry hydroprocessing process generally involves passing slurry effluent 105 through a slurry hydroprocessing reaction zone in the presence of hydrogen stream 106 and slurry hydroprocessing catalyst 108 under slurry hydroprocessing conditions to provide a slurry hydroprocessing effluent 112. The reaction catalyzed in slurry reactor 110 includes, for example, hydrodeoxygenation, hydrodenitrogenation, hydrodesulfurization, and/or hydrodemetallization. In some embodiments, the catalyzed reaction includes at least hydrodeoxygenation such that first feedstock 101 including one or more of fats, oils and greases present in slurry effluent 105 is partially or fully converted into paraffinic compounds resulting in a first liquid effluent having a relatively high paraffinic content, e.g., an n-paraffin content greater than or equal to about 50 vol. %, or greater than or equal to about 60 vol. %, or greater than or equal to about 65 vol. % and up to about 95 vol. % while having a low aromatic content (e.g., an aromatic content of less than about 1 vol. %). In some embodiments, the degree of hydrodeoxygenation is greater than about 90%, or greater than about 95%.

In addition, second feedstock 102 including a solid biomass feedstock present in slurry effluent 105 is partially deoxygenated to provide a second liquid effluent having an aromatic content greater than or equal to about 10 vol. %, or greater than or equal to about 20 vol. %, or greater than or equal to about 30 vol. In some embodiments, the second liquid effluent can have an aromatic content of from about 10 vol. % to about 35 vol. %, or from about 10 vol. % to about 20 vol. %. In addition, in some embodiments, the second liquid effluent has a high cyclic hydrocarbon content, e.g., greater than or equal to 60 vol. % and a low n-paraffin content, e.g., less than or equal to about 25 vol. %. In some embodiments, the degree of hydrodeoxygenation is greater than about 80%, or greater than about 90%.

The hydroprocessing reaction in the slurry hydroprocessing zone results in the formation of slurry hydroprocessing effluent 112. In some embodiments, slurry hydroprocessing effluent 112 containing the first liquid effluent and the second liquid effluent can have an n-paraffin content of from about 60 vol. % to about 95 vol. % and an aromatic content of from about 10 vol. % to about 35 vol. %. In some embodiments, slurry hydroprocessing effluent 112 can have an n-paraffin content of from about 80 vol. % to about 90 vol. % and an aromatic content of from about 10 vol. % to about 20 vol. %. In some embodiments, slurry hydroprocessing effluent 112 can further have a naphthalene content of no more than about 3 vol. %.

In some embodiments, slurry hydroprocessing effluent 112 can be in the form of a gas-liquid-solid mixture. For example, slurry hydroprocessing effluent 112 can contain, in addition to the first liquid effluent and the second liquid effluent, char, light gases (C₁ to C₃ gases, CO, CO₂, and H₂), water vapor and catalyst slurry. Char can generally be removed from slurry reactor 110.

System 100 further includes a separation unit 114 for separating the gas, the first liquid effluent, the second liquid effluent and catalyst slurry. Separation unit 114 can have one or more separation units including, for example, gas/liquid separators, including hot high- and low-pressure separators, intermediate high- and low-pressure separators, cold high- and low-pressure separators, strippers, integrated strippers and combinations thereof. Integrated strippers include strippers that are integrated with hot high- and low-pressure separators, intermediate high- and low-pressure separators, cold high- and low-pressure separators. For example, a gas stream 116 containing at least the light gases exits separation unit 114 where it can be sent for storage or further processing. A catalyst slurry stream 118 exits separation unit 114 where a portion of catalyst slurry stream 118 may be withdrawn from separation unit 114 via a bleed stream 122 continuously or semi-continuously and another portion is recycled back to slurry reactor 110 as a recycled catalyst slurry stream 120. Recycled catalyst slurry stream 120 is sent back to slurry reactor 110 where it can be reused in the slurry hydroprocessing processes as discussed above.

A liquid effluent 124 containing the first liquid effluent and the second liquid effluent exiting separation unit 114 is then sent to a hydrotreating unit 126 followed by an isomerization unit 130 for processing liquid effluent 124 containing the first liquid effluent and the second liquid effluent to cause hydrodeoxygenation and isomerization. Although system 100 shows hydrotreating unit 126 and isomerization unit 130 as separate units, this is merely illustrative and it is contemplated that hydrotreating unit 126 and isomerization unit 130 can be in the same reactor or separate reactors. In some embodiments, hydrotreating unit 126 and isomerization unit 130 are in a stacked bed relationship. In some embodiments, hydrotreating unit 126 and isomerization unit 130 have fixed-bed catalysts and operate in a co-current trickle flow.

In some embodiments, the processing of liquid effluent 124 may be performed, for example, in a two-step process involving hydrodeoxygenation followed by isomerization, such as an ISOTERRA process, available from Chevron Lummus Global.

In a non-limiting illustrative embodiment, liquid effluent 124 enters a hydrodeoxygenation zone in hydrotreating unit 126 in the presence of a hydrodeoxygenation catalyst and hydrogen and is operated at conditions sufficient to cause a hydrodeoxygenation reaction to produce a hydrodeoxygenated liquid effluent 128. In this way, at least a portion of the phenolic rings in the second effluent is converted to saturated rings and at least a portion of olefinic compounds is converted to paraffinic compounds.

A hydrodeoxygenation catalyst for use in hydrotreating unit 126 may be any suitable hydrodeoxygenation catalyst known to those skilled in the art. In some embodiments, the hydrodeoxygenation catalyst includes, for example, hydrodeoxygenation catalyst such as CoMo, NiMo, NiW, CoNiMo on a support. Suitable supports include, for example, alumina, silica, alumina-silica, and zirconia.

In some embodiments, the hydrodeoxygenation reaction may be conducted under hydrodeoxygenation reaction conditions including, for example, a pressure of from about 300 psig to about 2500 psig, a temperature of from 200° C. to about 500° C. (e.g., about 250° C. to about 400° C.), a weight hourly space velocity (WHSV) of from about 0.1 h⁻¹ to about 10 h⁻¹ (e.g., about 0.2 h⁻¹ to about 5 h⁻¹), and a hydrogen flow of from about 350 to about 900 NL H₂/L feed. The ratio of hydrogen gas to liquid effluent 124 supplied to the hydrogenation zone can be in a range of from about 100 to about 1500 normal L (at standard conditions of 0° C. and 1 atm (0.1 MPa)) per kg of liquid effluent 124.

In some embodiments, hydrodeoxygenated liquid effluent 128 can be withdrawn from hydrotreating unit 126 and flowed to a hydrotreating separation unit (not shown), where a gas-phase portion can be separated from a liquid-phase portion.

Hydrodeoxygenated liquid effluent 128 is sent to a hydroisomerization zone in isomerization unit 130 provided with a hydroisomerization catalyst and hydrogen. The hydroisomerization zone is operated at conditions sufficient to cause a hydroisomerization reaction of hydrodeoxygenated liquid effluent 128 thereby producing a liquid hydrocarbon product 132. In this way, n-paraffins in the first liquid effluent are converted to iso-paraffins.

The hydroisomerization catalyst may be any suitable hydroisomerization catalyst composition known to those skilled in the art. In some embodiments, a suitable hydroisomerization catalyst includes, for example, a Group 8-10 metal of the IUPAC Periodic Table of Elements and a zeolitic material. In some embodiments, the hydroisomerization catalyst may further include a binder, such as, for example, silica, alumina, silica-alumina, and combinations thereof. In some embodiments, the Group 8-10 metal includes, for example platinum, palladium, nickel, and combinations thereof. In some embodiments, the Group 8-10 metal is a noble metal including, for example, ruthenium, rhodium, palladium, osmium, iridium, and platinum. In some embodiments, the hydroisomerization catalyst comprises the at least one noble metal in a concentration of from 0.01 wt. % to about 5 wt. %. When the Group 8-10 metal is Ni, the hydroisomerization catalyst can also include a Group 6 metal, such as Mo or W. In some embodiments, a zeolitic material includes, for example, Beta, COK-7, EU-1, EU-2, EU-11, IZM-1, MCM-22, NU-10, SSZ-32, SSZ-91, ZSM-5, ZSM-12, ZSM-22, ZSM-23, ZSM-30, ZSM-35, ZSM-48, ZSM-50, ZSM-57, and combinations thereof.

In some embodiments, the hydroisomerization reaction may be conducted under hydroisomerization reaction conditions including, for example, a pressure in a range of from about 300 psig to about 3000 psig and a temperature in a range of from about 150° C. to about 400° C. In some embodiments, the hydroisomerization reaction may be conducted at a pressure in a range of from about 2 MPa to about 17 MPa, and a temperature in a range of from about 200° C. to about 360° C. In some embodiments, the LHSV is in a range of from about 0.2 h⁻¹ to about 4 h⁻¹ based on fresh feed. The ratio of the hydrogen gas to hydrodeoxygenated liquid effluent 128 supplied to hydroisomerization unit 130 is in a range of from about 100 to about 1500 normal L (at standard conditions of 0° C. and 1 atm (0.1 MPa)) per kg of hydrodeoxygenated liquid effluent 128.

In some embodiments, the hydrogen may be produced, for example, by water electrolysis. The water electrolysis process may be powered by renewable energy (such as solar photovoltaic, wind or hydroelectric power) to generate green hydrogen, nuclear energy or by non-renewable power from other sources (grey hydrogen).

Liquid hydrocarbon product 132 obtained from isomerization unit 130 has a second n-paraffin content and a second aromatic content. In some embodiments, the second n-paraffin content of liquid hydrocarbon product 132 is less than about 40 vol. %, e.g., in a range of from about 10 vol. % to about 30 vol. %, or from about 15 vol. % to about 25 vol. %. The targeted n-paraffin content may be selected, for example, on the desired cloud point specification for a desired fuel product/component. In some embodiments, the second aromatic content of liquid hydrocarbon product 132 is in a range of from at least 8 vol. % to about 25 vol. %, or from at least 8 vol. % to about 20 vol. %. In some embodiments, liquid hydrocarbon product 132 can further have a naphthalene content of from about 2 vol. % to about 3 vol. %.

System 100 further includes a separation unit 134 for separating liquid hydrocarbon product 132 into desired various products, e.g., naphtha, light diesel, gasoil, heavy diesel, kerosene boiling point ranges. In some embodiments, liquid hydrocarbon product 132 may be fractionated (e.g., by distillation) into different fuel grades, each of which is known to be within a certain boiling point range. For example, fractionation may be conducted at a determined fractionation temperature or boiling point cut-off (e.g., about 120° C. to about 300° C., or about 300° C. to about 400° C.) to separate out various boiling point fractions appropriate to a desired fuel product and to collect olefinic light products for further processing. In some embodiments, liquid hydrocarbon product 132 is separated into such products as, for example, a first fractionated product 136 including, for example, renewable gasoline, a second fractionated product 138 including, for example, a sustainable aviation fuel, and a third fractionated product 140 including, for example, renewable diesel. Second fractionated product 138 including, for example, a sustainable aviation fuel can have an n-paraffin content and an aromatic content as discussed above for liquid hydrocarbon product 132.

In some embodiments, the sustainable aviation fuel has an n-paraffin content of about 10 vol. % to about 30 vol. % and an aromatic content of at least 8 vol. % to about 25 vol. %. In some embodiments, the sustainable aviation fuel has an n-paraffin content of about 15 vol. % to about 25 vol. % and an aromatic content of at least 8 vol. % to about 20 vol. %. In some embodiments, the sustainable aviation fuel further has an iso-paraffin to n-paraffin content of about 65:25.

According to an aspect of the present disclosure, a process for producing a liquid hydrocarbon comprises:
coprocessing a slurry hydroprocessing feed stream comprising a solid biomass feedstock and a liquid feedstock comprising one or more of fats, oils and greases in the presence of a slurry hydroprocessing catalyst and hydrogen in a slurry hydroprocessing zone and under slurry hydroprocessing conditions to produce a liquid hydroprocessing effluent having a first n-paraffin content greater than or equal to about 60 vol. % and a first aromatic content of greater than 10 vol. %, and
processing the liquid hydroprocessing effluent by subjecting the liquid hydroprocessing effluent to a hydrodeoxygenation catalyst and under hydrodeoxygenation reaction conditions to produce a hydrodeoxygenated liquid effluent, and subjecting the hydrodeoxygenated liquid effluent to a hydroisomerization catalyst and under hydroisomerization reaction conditions thereby producing a liquid hydrocarbon product having a second n-paraffin content less than the first n-paraffin content and a second aromatic content less than the first aromatic content.

In one or more additional illustrative embodiments, as may be combined with the preceding paragraphs, the solid biomass feedstock comprises lignin.

In one or more additional illustrative embodiments, as may be combined with the preceding paragraphs, the solid biomass feedstock is ground, pulverized, chipped or in a particulate, pellet, powder, shaving, chip, dust, or pulverized form, or a combination thereof.

In one or more additional illustrative embodiments, as may be combined with the preceding paragraphs, the liquid feedstock comprises one or more of animal fats, animal oils, plant fats, plant oils, vegetable fats, vegetable oils, greases, and used cooking oil.

In one or more additional illustrative embodiments, as may be combined with the preceding paragraphs, the slurry hydroprocessing feed stream comprises from about 10 wt. % to about 50 wt. % of the solid biomass feedstock and from about 50 wt. % to about 90 wt. % of the liquid feedstock.

In one or more additional illustrative embodiments, as may be combined with the preceding paragraphs, the slurry hydroprocessing catalyst comprises a metal comprising iron, nickel, molybdenum, zinc, vanadium, tungsten, cobalt, ruthenium, or combinations thereof.

In one or more additional illustrative embodiments, as may be combined with the preceding paragraphs, the coprocessing the slurry hydroprocessing feed stream comprising the solid biomass feedstock and the liquid feedstock is carried out in a slurry reactor system.

In one or more additional illustrative embodiments, as may be combined with the preceding paragraphs, the slurry hydroprocessing conditions comprise a pressure in a range of from about 500 psig to about 3500 psig, a reactor temperature in a range from about 250° C. to about 500° C. and a liquid hourly space velocity (LHSV) below about 4 h⁻¹ on a fresh feed basis.

In one or more additional illustrative embodiments, as may be combined with the preceding paragraphs, the hydrodeoxygenation catalyst comprises a metal comprising nickel, molybdenum, cobalt, ruthenium, rhodium, palladium, silver, osmium, iridium, platinum, gold or combinations thereof on a support.

In one or more additional illustrative embodiments, as may be combined with the preceding paragraphs, the hydrodeoxygenation reaction conditions comprise a pressure of from about 300 psig to about 2500 psig, a temperature of from about 200° C. to about 500° C. and a weight hourly space velocity (WHSV) of from about 0.1 h⁻¹ to about 10 h⁻¹.

In one or more additional illustrative embodiments, as may be combined with the preceding paragraphs, the hydroisomerization catalyst comprises one or more of a Group 8-10 metal and a zeolitic material.

In one or more additional illustrative embodiments, as may be combined with the preceding paragraphs, the hydroisomerization reaction conditions comprise a pressure in a range of from about 300 psig to about 3000 psig and at a temperature in a range of from about 150° C. to about 400° C.

In one or more additional illustrative embodiments, as may be combined with the preceding paragraphs, the first n-paraffin content is from about 60 vol. % to about 95 vol. %, and the second n-paraffin content is less than about 40 vol. %.

In one or more additional illustrative embodiments, as may be combined with the preceding paragraphs, the first aromatic content is from about 10 vol. % to about 35 vol. %, and the second aromatic content is from at least 8 vol. % to about 25 vol. %.

In one or more additional illustrative embodiments, as may be combined with the preceding paragraphs, the first n-paraffin content is from about 60 vol. % to about 95 vol. %, and the second n-paraffin content is less than about 40 vol. %, and the first aromatic content is from about 10 vol. % to about 35 vol. %, and the second aromatic content is from at least 8 vol. % to about 25 vol. %.

In one or more additional illustrative embodiments, as may be combined with the preceding paragraphs, the process further comprises fractioning the liquid hydrocarbon product at a selected fractionation temperature to obtain individual fractions, wherein a given individual fraction is a sustainable aviation fuel.

In one or more additional illustrative embodiments, as may be combined with the preceding paragraphs, the sustainable aviation fuel has an n-paraffin content of about 10 vol. % to about 30 vol. % and an aromatic content of at least 8 vol. % to about 20 vol. %.

In one or more additional illustrative embodiments, as may be combined with the preceding paragraphs, another given individual fraction is one or more of a renewable gasoline or a renewable diesel fuel.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A process for producing a liquid hydrocarbon, comprising:
coprocessing a slurry hydroprocessing feed stream comprising a solid biomass feedstock and a liquid feedstock comprising one or more of fats, oils and greases in the presence of a slurry hydroprocessing catalyst and hydrogen in a slurry hydroprocessing zone and under slurry hydroprocessing conditions to produce a liquid hydroprocessing effluent having a first n-paraffin content greater than or equal to about 60 vol. % and a first aromatic content of greater than 10 vol. %; and
processing the liquid hydroprocessing effluent by subjecting the liquid hydroprocessing effluent to a hydrodeoxygenation catalyst and under hydrodeoxygenation reaction conditions to produce a hydrodeoxygenated liquid effluent, and subjecting the hydrodeoxygenated liquid effluent to a hydroisomerization catalyst and under hydroisomerization reaction conditions thereby producing a liquid hydrocarbon product having a second n-paraffin content less than the first n-paraffin content and a second aromatic content less than the first aromatic content.

2. The process according to claim 1, wherein the solid biomass feedstock comprises lignin.

3. The process according to claim 2, wherein the solid biomass feedstock is ground, pulverized, chipped or in a particulate, pellet, powder, shaving, chip, dust, or pulverized form, or a combination thereof.

4. The process according to claim 1, wherein the liquid feedstock comprises one or more of animal fats, animal oils, plant fats, plant oils, vegetable fats, vegetable oils, greases, and used cooking oil.

5. The process according to claim 1, wherein the slurry hydroprocessing feed stream comprises from about 10 wt. % to about 50 wt. % of the solid biomass feedstock and from about 50 wt. % to about 90 wt. % of the liquid feedstock.

6. The process according to claim 1, wherein the slurry hydroprocessing catalyst comprises a metal comprising iron, nickel, molybdenum, zinc, vanadium, tungsten, cobalt, ruthenium, or combinations thereof.

7. The process according to claim 1, wherein the coprocessing the slurry hydroprocessing feed stream comprising the solid biomass feedstock and the liquid feedstock is carried out in a slurry reactor system.

8. The process according to claim 1, wherein the slurry hydroprocessing conditions comprise a pressure in a range of from about 500 psig to about 3500 psig, a reactor temperature in a range from about 250° C. to about 500° C. and a liquid hourly space velocity (LHSV) below about 4 h⁻¹ on a fresh feed basis.

9. The process according to claim 1, wherein the hydrodeoxygenation catalyst comprises a metal comprising nickel, molybdenum, cobalt, ruthenium, rhodium, palladium, silver, osmium, iridium, platinum, gold or combinations thereof on a support.

10. The process according to claim 1, wherein the hydrodeoxygenation reaction conditions comprise a pressure of from about 300 psig to about 2500 psig, a temperature of from about 200° C. to about 500° C. and a weight hourly space velocity (WHSV) of from about 0.1 h⁻¹ to about 10 h⁻¹.

11. The process according to claim 1, wherein the hydroisomerization catalyst comprises one or more of a Group 8-10 metal and a zeolitic material.

12. The process according to claim 1, wherein the hydroisomerization reaction conditions comprise a pressure in a range of from about 300 psig to about 3000 psig and at a temperature in a range of from about 150° C. to about 400° C.

13. The process according to claim 1, wherein the first n-paraffin content is from about 60 vol. % to about 95 vol. %, and the second n-paraffin content is less than about 40 vol. %.

14. The process according to claim 1, wherein the first aromatic content is from about 10 vol. % to about 35 vol. %, and the second aromatic content is from at least 8 vol. % to about 25 vol. %.

15. The process according to claim 1, wherein the first n-paraffin content is from about 60 vol. % to about 95 vol. %, and the second n-paraffin content is less than about 40 vol. %, and the first aromatic content is from about 10 vol. % to about 35 vol. %, and the second aromatic content is from at least 8 vol. % to about 25 vol. %.

16. The process according to claim 1, further comprising fractioning the liquid hydrocarbon product at a selected fractionation temperature to obtain individual fractions, wherein a given individual fraction is a sustainable aviation fuel.

17. The process according to claim 16, wherein the sustainable aviation fuel has an n-paraffin content of about 10 vol. % to about 30 vol. % and an aromatic content of at least 8 vol. % to about 20 vol. %.

18. The process according to claim 16, wherein another given individual fraction is one or more of a renewable gasoline or a renewable diesel fuel.

19. A product produced from the process of claim 1.

20. A sustainable aviation fuel produced from the process of claim 16.
